(19) United States
(12) Patent Application Publication
(10) Pub. No.: US 2012/0243157 A1
(43) Pub. Date: Sep. 27, 2012

(54) CONTAINER DATA CENTER

(75) Inventor: TSUNG-YUAN CHEN, Tu-Cheng (TW)

(73) Assignee: HON HAI PRECISION INDUSTRY CO., LTD., Tu-Cheng (TW)

(21) Appl. No.: 13/086,396

(22) Filed: Apr. 14, 2011

(30) Foreign Application Priority Data
Mar. 21, 2011 (TW) 100109614

(51) Int. Cl. G06F 1/16

(52) U.S. Cl. 361/679.02

(57) ABSTRACT

A container data center includes a container and a number of server systems. A number of dividing plates is set in the container to divide the container into a number of shielding spaces each receiving one of a number of server systems. The dividing plates each include an electromagnetic shield layer made of electromagnetic shield material to prevent electromagnetic interference between the server systems.

### BACKGROUND

1. Technical Field

The present disclosure relates to a container data center.

2. Description of Related Art

With increasing heavy duty use of on-line applications, the need for computer data centers has increased rapidly. Data centers are centralized computing facilities that include many servers, often arranged on server racks or shelves, and one rack or shelf with some servers can be considered a server system. During operation, electromagnetic interference is generated between the server systems because of so many servers in proximity of each other.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an exemplary embodiment of a container data center, the container data center including a plurality of dividing plates.

FIG. 2 is a partial, schematic, isometric view of one of the dividing plate of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

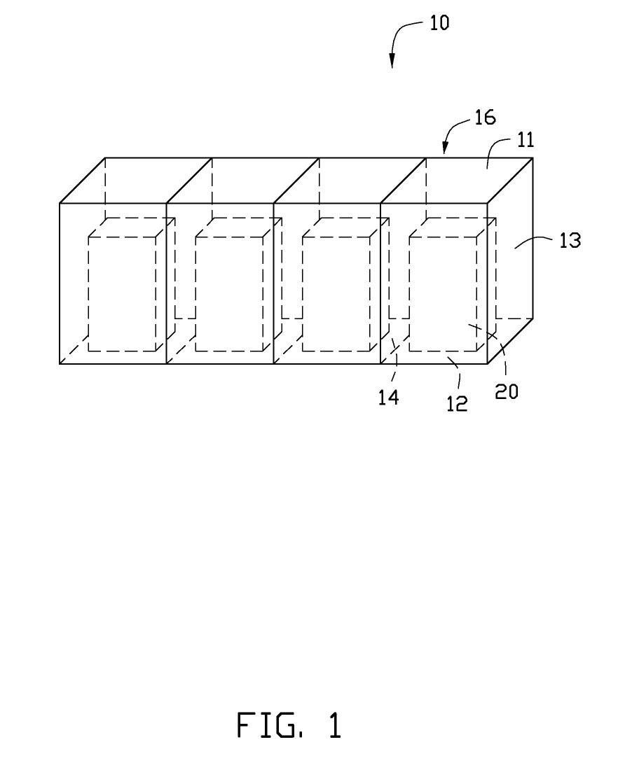

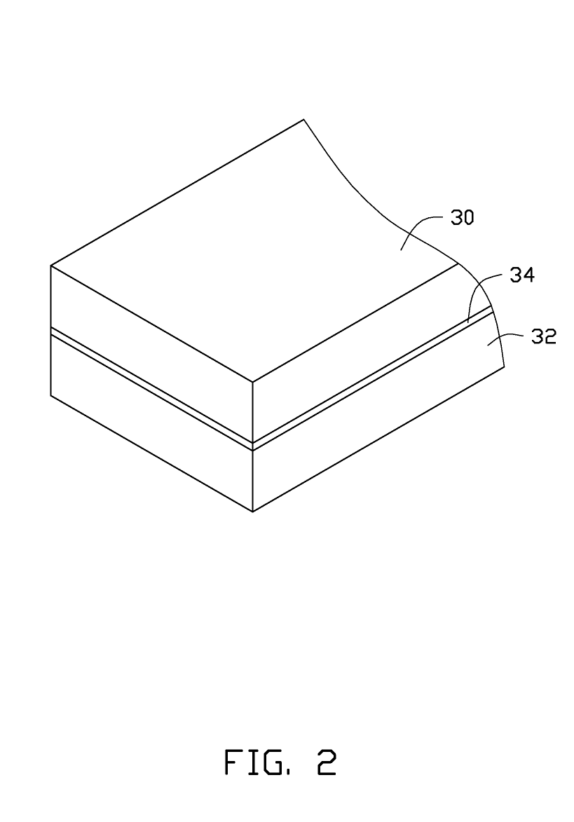

Referring to FIGS. 1 and 2, an exemplary embodiment of a container data center includes a portable container 10, and a plurality of server systems 20 received in the container 10 and arranged in a row.

The container 10 is substantially rectangular and includes a top wall 11, a bottom wall 12 opposite to the top wall 11, and four sidewalls 13 perpendicularly connected between corresponding sides of the top wall 11 and the bottom wall 12. The four sidewalls 13 include a left sidewall, a right sidewall, a front sidewall, and a rear sidewall. A plurality of spaced dividing plates 14 is substantially, perpendicularly set on the bottom wall 12 of the container 10, and is parallel to the right sidewall of the container to divide the container 10 into a plurality of shielding spaces 16. The dividing plate 14 includes a first insulating layer 30, a second insulating layer 32, and an electromagnetic shielding layer 34 sandwiched between the first and the second insulating layers 30 and 32. The electromagnetic shielding layer 34 is made of electromagnetic shielding material. In this embodiment, the electromagnetic shielding layer 34 is a conductive wire net or a conductive coating.

Each server system 20 is received in a corresponding one of the shielding spaces 16. During the operation of the server systems 20, the shielding spaces 16 shield electromagnetic interference generated by the server systems 20 from each other.

In this embodiment, the top wall 11, the bottom wall 12, and the four sidewalls 13 each include a first insulating layer 30, a second insulating layer 32, and an electromagnetic shielding layer 34 sandwiched between the first and the second insulating layers 30 and 32. Thus, the container 10 can be electrically connected to the ground by a cable connected between the electromagnetic shielding layer 34 and ground, which is convenient for eliminating static electricity.

In this embodiment, the first insulating layer 30 and the second insulating layer 32 are made of glass or plastic. If the first insulating layer 30 and the second insulating layer 32 are made of glass, it is very convenient for users to observe the server systems 20.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

1. A container data center comprising:
a portable container;
a plurality of server systems received in the container; and
a plurality of dividing plates set in the container to divide the container into a plurality of shielding spaces each receiving one of the plurality of server systems;
wherein each of the dividing plates comprises a shielding layer made of electromagnetic shield material to prevent electromagnetic interference between the server systems.

2. The container data center of claim 1, wherein each dividing plate further comprises a first insulating layer, and a second insulating layer, the shielding layer is sandwiched between the first and second insulating layers.

3. The container data center of claim 2, wherein the container comprises a top wall, a bottom wall, and sidewalls connected between corresponding sides of the top wall and bottom wall, each of the top wall, the bottom wall, and the sidewalls comprising a first insulating layer, a second insulating layer, and an electromagnetic shielding layer sandwiched between the first and the second insulating layers.

4. The container data center of claim 3, wherein the first and the second insulating layers of the walls are made of glass or plastic.

5. The container data center of claim 3, wherein the electromagnetic shielding layer of each wall is a conductive wire net or a conductive coating.

6. The container data center of claim 2, wherein the electromagnetic shielding layer is a conductive wire net or a conductive coating.

7. The container data center of claim 2, wherein the first and the second insulating layers of the walls are made of glass or plastic.
